(19) United States
(12) Patent Application Publication
(10) Pub. No.: US 2025/0069578 A1
(43) Pub. Date: Feb. 27, 2025

(54) LISTENING APPARATUS AND CONTROL METHOD OF LISTENING APPARATUS

(71) Applicant: JVCKENWOOD Corporation, Yokohama-shi (JP)

(72) Inventors: Koichi MATSUMOTO, Yokohama-shi (JP); Hirokazu NISHIJIMA, Yokohama-shi (JP); Hiromi SAKAIRI, Yokohama-shi (JP); Shuji TANIFUJI, Yokohama-shi (JP)

(21) Appl. No.: 18/946,542

(22) Filed: Nov. 13, 2024

Related U.S. Application Data
(63) Continuation of application No. PCT/JP2023/019331, filed on May 24, 2023.

(30) Foreign Application Priority Data
Jun. 14, 2022 (JP) 2022-095827

(51) Int. Cl. G10K 11/178; G10K 11/00

(52) U.S. Cl. CPC G10K 11/17823; G10K 11/002; G10K 2210/1081

(57) ABSTRACT

A listening apparatus of the present disclosure generates an environmental sound suppression signal having a reversed phase with respect to an environmental signal corresponding to an detected environmental sound, and outputs a reproduction signal that is obtained by superimposing the environmental sound suppression signal on a sound source signal. The listening apparatus generates an environmental sound amplification signal having the same phase as the environmental signal instead of the environmental sound suppression signal, in a case where it is determined that the level of the environmental sound is equal to or greater than a predetermined threshold and that an amount of change per predetermined period of time in the level of the environmental sound is equal to or greater than a predetermined value; and outputs a reproduction signal that is obtained by superimposing the environmental sound amplification signal on the sound source signal.

### CROSS REFERENCE TO RELATED APPLICATION

This application is based upon and claims the benefit of priority from Japanese patent application No. 2022-095827, filed on Jun. 14, 2022, the disclosure of which is incorporated herein in its entirety by reference.

### BACKGROUND

The present disclosure relates to a listening apparatus, and a control method of the listening apparatus.

When one walks while wearing a listening apparatus such as noise-cancelling headphones or earphones, a noise-cancelling effect makes it difficult to grasp a surrounding state. For example, in Japanese Unexamined Patent Application Publication No. 2016-006925, a headset includes an audio output unit, a sound collection unit, a determination unit, and a notification unit, and the sound collection unit collects ambient sounds, and the determination unit determines whether a sound pressure change rate of a specific sound included in the ambient sounds exceeds a threshold or not. The notification unit issues a predetermined notification to a user based on a determination result of the determination unit.

With a technology according to Japanese Unexamined Patent Application Publication No. 2016-006925, even in a state where noise is cancelled, a user is notified of a surrounding state by a sound such as guidance, an alarm sound or a specific sound when there is a danger. However, with the technology according to Japanese Unexamined Patent Application Publication No. 2016-006925, there is a problem that the user is not able to grasp an ambient sound, or in other words, an environmental sound. For example, if the user is able to grasp what kind of sound an environmental sound is, more options can be provided to the user regarding how to cope in a dangerous situation.

### SUMMARY

A listening apparatus of the present disclosure includes:
an environmental sound detection unit configured to generate an environmental signal corresponding to an environmental sound that is detected;
an environmental sound suppression signal generation unit configured to generate an environmental sound suppression signal having a reversed phase with respect to the environmental signal;
a reproduction signal output unit configured to output a reproduction signal that is obtained by superimposing the environmental sound suppression signal on a sound source signal; and
a monitoring unit configured to monitor a level of the environmental sound based on the environmental signal, in which
the environmental sound suppression signal generation unit generates an environmental sound amplification signal having the same phase as the environmental signal instead of the environmental sound suppression signal, in a case where it is determined by the monitoring unit that the level of the environmental sound is equal to or greater than a predetermined threshold and that an amount of change per predetermined period of time in the level of the environmental sound is equal to or greater than a predetermined value, and
the reproduction signal output unit outputs a reproduction signal that is obtained by superimposing the environmental sound amplification signal on the sound source signal.

A control method of a listening apparatus of the present disclosure includes:
generating an environmental signal corresponding to an environmental sound that is detected;
generating an environmental sound suppression signal having a reversed phase with respect to the environmental signal;
outputting a reproduction signal that is obtained by superimposing the environmental sound suppression signal on a sound source signal;
monitoring a level of the environmental sound based on the environmental signal; and
generating an environmental sound amplification signal having the same phase as the environmental signal instead of the environmental sound suppression signal, in a case where it is determined that the level of the environmental sound is equal to or greater than a predetermined threshold and that an amount of change per predetermined period of time in the level of the environmental sound is equal to or greater than a predetermined value, and outputting a reproduction signal that is obtained by superimposing the environmental sound amplification signal on the sound source signal.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing an example of a configuration of listening apparatuses according to first and second embodiments;

FIG. 2 is a flowchart showing an example of an operation of the listening apparatus according to the first embodiment;

FIG. 3 is a diagram showing an example of an environmental sound suppression signal or an environmental sound amplification signal generated from an environmental sound by the listening apparatus according to the first embodiment, and an example of a noise-cancelling effect thereof;

FIG. 4 is a flowchart showing an example of an operation of the listening apparatus according to the second embodiment;

FIG. 5 is a flowchart showing another example of the operation of the listening apparatus according to the second embodiment;

FIG. 6 is a diagram showing an example of an environmental sound suppression signal or an environmental sound amplification signal generated from an environmental sound by the listening apparatus according to the second embodiment, and an example of a noise-cancelling effect thereof;

FIG. 7 is a diagram showing an example of the environmental sound suppression signal or the environmental sound amplification signal generated from the environmental sound by the listening apparatus according to the second embodiment, and an example of the noise-cancelling effect thereof; and

FIG. 8 is a block diagram showing an example of a configuration of a computer according to the first and second embodiments.

### DETAILED DESCRIPTION

Hereinafter, specific embodiments to which the present invention is applied will be described in detail with reference to the drawings. In the drawings, same elements are denoted by the same reference sign, and redundant description will be omitted as necessary for the sake of clarity of description.

### First Embodiment

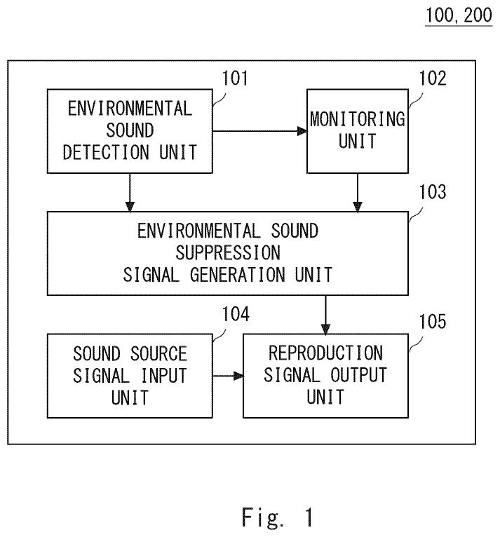

First, a configuration of a listening apparatus 100 according to a first embodiment will be described with reference to FIG. 1.

FIG. 1 is a block diagram showing an example of the configuration of the listening apparatus 100 according to the first embodiment. The listening apparatus 100 is a noise-cancelling earphone or headset, for example. The listening apparatus 100 includes an environmental sound detection unit 101, a monitoring unit 102, an environmental sound suppression signal generation unit 103, a sound source signal input unit 104, and a reproduction signal output unit 105.

The environmental sound detection unit 101 is a microphone or the like, and the environmental sound detection unit 101 detects an environmental sound around a user wearing the listening apparatus 100, and generates an environmental signal corresponding to the detected environmental sound. The environmental sound is a sound of vehicles, a sound of a conversation between people, and the like.

The monitoring unit 102 monitors a level of the environmental sound based on the environmental signal. More specifically, the monitoring unit 102 determines whether the level of the environmental sound is equal to or greater than a predetermined threshold or not. Furthermore, the monitoring unit 102 determines whether an amount of change per predetermined period of time in the level of the environmental sound is equal to or greater than a predetermined value or not.

The environmental sound suppression signal generation unit 103 generates a signal for suppressing the environmental sound that is heard by the user, or in other words, an environmental sound suppression signal that has a reversed phase with respect to the environmental signal. Here, in the case where it is determined by the monitoring unit 102 that the level of the environmental sound is equal to or greater than the predetermined threshold and that the amount of change per predetermined period of time in the environmental sound is equal to or greater than the predetermined value, the environmental sound suppression signal generation unit 103 performs the following process. The environmental sound suppression signal generation unit 103 generates, instead of the environmental sound suppression signal, a signal for amplifying the environmental sound that is heard by the user, or in other words, an environmental sound amplification signal having a same phase as the environmental signal. Then, in the case where the level of the environmental sound does not remain above the predetermined threshold after a lapse of a predetermined period of time from generation of the environmental sound amplification signal, the environmental sound suppression signal generation unit 103 generates the environmental sound suppression signal instead of the environmental sound amplification signal.

Additionally, in the case where it is determined by the monitoring unit 102 that the level of the environmental sound is equal to or greater than the predetermined threshold and that the amount of change per predetermined period of time in the level of the environmental sound is equal to or greater than the predetermined value, the environmental sound suppression signal generation unit 103 may alternatively stop the environmental sound suppression signal without generating the environmental sound amplification signal.

A signal of a sound source sound (hereinafter “sound source signal”) that is to be reproduced by the listening apparatus 100 is input to the sound source signal input unit 104 from a sound source such as a music player.

The reproduction signal output unit 105 is a speaker or the like, and the reproduction signal output unit 105 converts a reproduction signal that is obtained by superimposing the environmental sound suppression signal or the environmental sound amplification signal on the sound source signal into a reproduction sound, and outputs the reproduction sound.

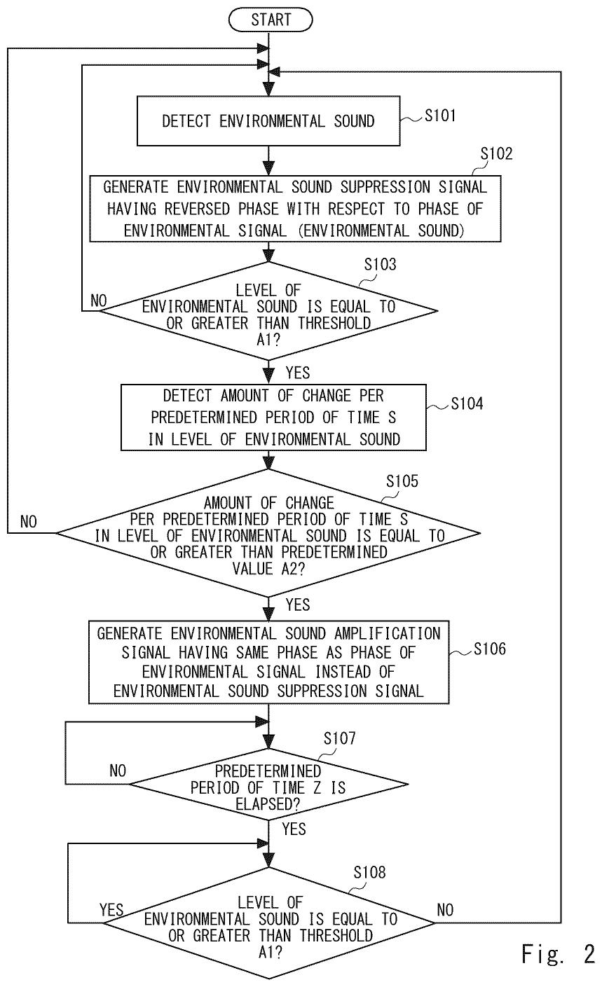

Next, an operation of the listening apparatus 100 according to the first embodiment will be described with reference to FIG. 2. FIG. 2 is a flowchart showing an example of an operation of the listening apparatus 100 according to the first embodiment.

As shown in FIG. 2, first, the environmental sound detection unit 101 of the listening apparatus 100 detects an environmental sound around a user wearing the listening apparatus 100 (step S101). Then, the environmental sound detection unit 101 generates an environmental signal corresponding to the detected environmental sound.

Next, the environmental sound suppression signal generation unit 103 reverses a phase of the environmental signal, and generates an environmental sound suppression signal having a reversed phase with respect to the environmental signal (step S102). The reproduction signal output unit 105 converts a reproduction signal that is obtained by superimposing the environmental sound suppression signal on a sound source signal, into a reproduction sound, and outputs the reproduction sound. The listening apparatus 100 thus performs a process of cancelling the environmental sound in the reproduction sound that is to be heard by the user.

Next, the monitoring unit 102 determines whether the level of the environmental sound is equal to or greater than a threshold A1 or not (step S103). As the threshold A1, a value that enables detection of a danger to a user is set.

In the case where the level of the environmental sound is determined to be not equal to or greater than the threshold A1 (NO in step S103), the listening apparatus 100 returns to the process in step S101. On the other hand, in the case where the level of the environmental sound is determined to be equal to or greater than the threshold A1 (YES in step S103), the monitoring unit 102 detects an amount of change per predetermined period of time S in the level of the environmental sound (step S104). The predetermined period of time S is 500 ms, for example.

Next, the monitoring unit 102 determines whether the amount of change per predetermined period of time S in the level of the environmental sound is equal to or greater than a predetermined value A2 or not (step S105). As in the case of the threshold A1, a value that enables detection of a danger to a user is set as the predetermined value A2.

In the case where the amount of change per predetermined period of time S in the level of the environmental sound is determined to be not equal to or greater than the predetermined value A2 (NO in step S105), the listening apparatus 100 returns to the process in step S101. On the other hand, in the case where the amount of change per predetermined period of time S in the level of the environmental sound is determined to be equal to or greater than the predetermined value A2 (YES in step S105), the environmental sound suppression signal generation unit 103 generates, instead of the environmental sound suppression signal, the environmental sound amplification signal having the same phase as the environmental signal (step S106). Amplitude of the environmental sound amplification signal can be set according to a desired extent of amplification of the environmental sound to be heard by the user. At this time, the reproduction signal output unit 105 outputs the reproduction signal that is obtained by superimposing the environmental sound amplification signal on the sound source signal. The listening apparatus 100 thus performs the process of amplifying the environmental sound in the reproduction sound that is to be heard by the user.

Additionally, in step S106, the environmental sound suppression signal generation unit 103 may alternatively stop the environmental sound suppression signal without generating the environmental sound amplification signal.

Next, the monitoring unit 102 determines whether there is a lapse of a predetermined period of time Z from the process in step S106 or not (step S107). In the case where it is determined that the predetermined period of time Z is not elapsed (NO in step S107), the monitoring unit 102 returns to the process in step S107. On the other hand, in the case where it is determined that the predetermined period of time Z is elapsed (YES in step S107), the monitoring unit 102 determines whether the level of the environmental sound is equal to or greater than the threshold A1 or not (step S108). In the case where the level of the environmental sound is determined to be equal to or greater than the threshold A1 (YES in step S108), the listening apparatus 100 returns to the process in step S108. On the other hand, in the case where it is determined that the level of the environmental sound is not equal to or greater than the threshold A1 (NO in step S108), the listening apparatus 100 returns to the process in step S101.

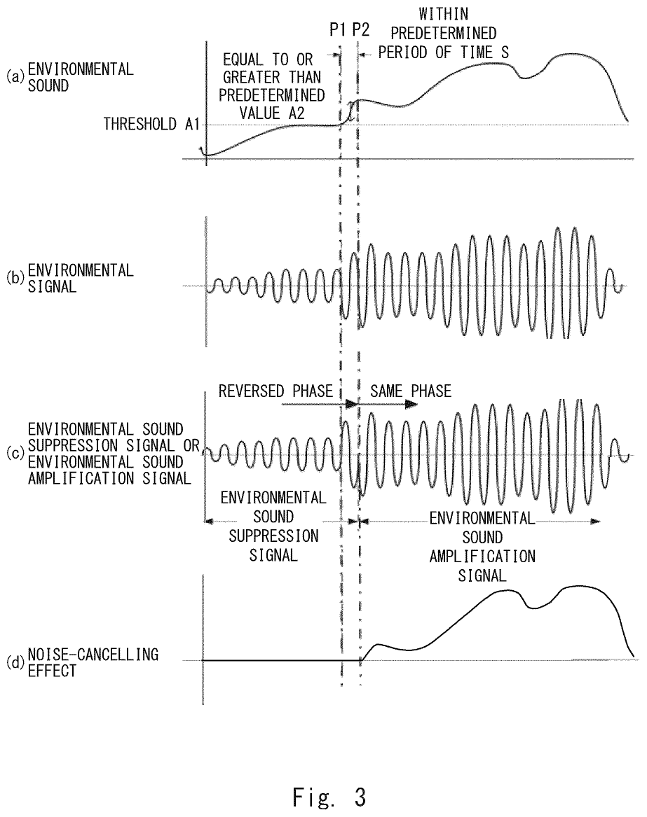

Next, the environmental sound suppression signal or the environmental sound amplification signal that is generated from the environmental sound by the listening apparatus 100 according to the first embodiment, and a noise-cancelling effect thereof will be described with reference to FIG. 3.

FIGS. 3(a) to 3(d) are diagrams showing the environmental sound suppression signal or the environmental sound amplification signal that is generated from the environmental sound by the listening apparatus 100 according to the first embodiment, and a noise-cancelling effect thereof. FIG. 3(a) is a graph showing the level of the environmental sound per unit time. A horizontal axis indicates time (ms), and a vertical axis indicates a level (dB) of the environmental sound. FIG. 3(b) is a graph showing a waveform of the environmental signal. A horizontal axis indicates time (ms), and a vertical axis indicates amplitude (dB) of the environmental signal. Furthermore, FIG. 3(c) is a graph showing a waveform of the environmental sound suppression signal or the environmental sound amplification signal. A horizontal axis indicates time (ms), and a vertical axis indicates amplitude (dB) of the environmental signal. FIG. 3(d) is a graph showing a noise-cancelling effect. A horizontal axis indicates time (ms), and a vertical axis indicates a noise-cancelling effect (dB). The smaller the value of the noise-cancelling effect, the smaller the noise, or in other words, the environmental sound, in the reproduction sound that is heard by the user.

As shown in FIG. 3(a), at a time point P1, the level of the environmental sound is determined by the monitoring unit 102 of the listening apparatus 100 to be equal to or greater than the threshold A1. At a time point P2, the amount of change per predetermined period of time S in the level of the environmental sound is determined by the monitoring unit 102 to be equal to or greater than the predetermined value A2.

As shown in FIGS. 3(b) and 3(c), up to the time point P2, the environmental sound suppression signal having a reversed phase with respect to the environmental signal is generated by the environmental sound suppression signal generation unit 103. Then, at a timing of the time point P2, the environmental sound amplification signal having the same phase as the environmental signal is generated by the environmental sound suppression signal generation unit 103. Accordingly, as shown in FIG. 3(d), the environmental sound heard by the user is cancelled until the time point P2. From the time point P2, the user is able to hear the environmental sound.

As described above, in the case where presence of an imminent danger to the user is determined by using the threshold A1 and the predetermined value A2, the listening apparatus 100 according to the first embodiment generates, instead of the environmental sound suppression signal, a signal for amplifying the environmental sound to be heard by the user, or in other words, the environmental sound amplification signal having the same phase as the environmental signal. Accordingly, with the listening apparatus 100, the user may perceive the environmental sound when there is a danger, even in a state where the noise is cancelled. The user may thus take various actions in response to the danger.

Furthermore, with the technology according to Patent Literature 1, a notification can be issued to the user only when an environmental sound that is given as a specific sound in advance is detected. However, with the listening apparatus 100, the environmental sound to be detected when there is an imminent danger to the user is not limited to a specific sound.

### Second Embodiment

Next, a configuration of a listening apparatus 200 according to a second embodiment will be described.

The listening apparatus 200 according to the second embodiment includes the environmental sound detection unit 101, the monitoring unit 102, the environmental sound suppression signal generation unit 103, the sound source signal input unit 104, and the reproduction signal output unit 105 of the listening apparatus 100 according to the first embodiment.

Following functions are added to the listening apparatus 100 according to the first embodiment to achieve the listening apparatus 200 according to the second embodiment.

With the listening apparatus 100 according to the first embodiment, the environmental sound suppression signal generation unit 103 generates a signal for suppressing the environmental sound that is to be heard by the user, or in other words, the environmental sound suppression signal having a reversed phase with respect to the environmental signal corresponding to the environmental sound. Furthermore, in the case where it is determined by the monitoring unit 102 that the level of the environmental sound is equal to or greater than the predetermined threshold and that the amount of change per predetermined period of time in the environmental sound is equal to or greater than the predetermined value, the environmental sound suppression signal generation unit 103 generates, instead of the environmental sound suppression signal, a signal for amplifying the environmental sound that is to be heard by the user, or in other words, the environmental sound amplification signal having the same phase as the environmental signal.

By contrast, with the listening apparatus 200 according to the second embodiment, in the case where it is determined by the monitoring unit 102 that the level of the environmental sound is equal to or greater than the predetermined threshold and that the amount of change per predetermined period of time in the level of the environmental sound is equal to or greater than the predetermined value, the environmental sound suppression signal generation unit 103 reduces amplitude of the environmental sound suppression signal over time, and then, generates the environmental sound amplification signal instead of the environmental sound suppression signal, and increases amplitude of the environmental sound amplification signal over time. Moreover, the environmental sound suppression signal generation unit 103 determines, based on the amount of change per predetermined period of time in the level of the environmental sound, at least one of an amount of reduction over time in the environmental sound suppression signal and an amount of increase over time in the environmental sound amplification signal.

Moreover, with the listening apparatus 100 according to the first embodiment, the environmental sound suppression signal generation unit 103 generates the environmental sound suppression signal instead of the environmental sound amplification signal, in a case where the level of the environmental sound is not equal to or greater than the predetermined threshold after a lapse of a predetermined period of time from generation of the environmental sound amplification signal.

By contrast, with the listening apparatus 200 according to the second embodiment, the environmental sound suppression signal generation unit 103 reduces the amplitude of the environmental sound amplification signal over time, in a case where the level of the environmental sound is not equal to or greater than the predetermined threshold after a lapse of a predetermined period of time from generation of the environmental sound amplification signal. Then, the environmental sound suppression signal generation unit 103 generates the environmental sound suppression signal instead of the environmental sound amplification signal, and increases the amplitude of the environmental sound suppression signal over time.

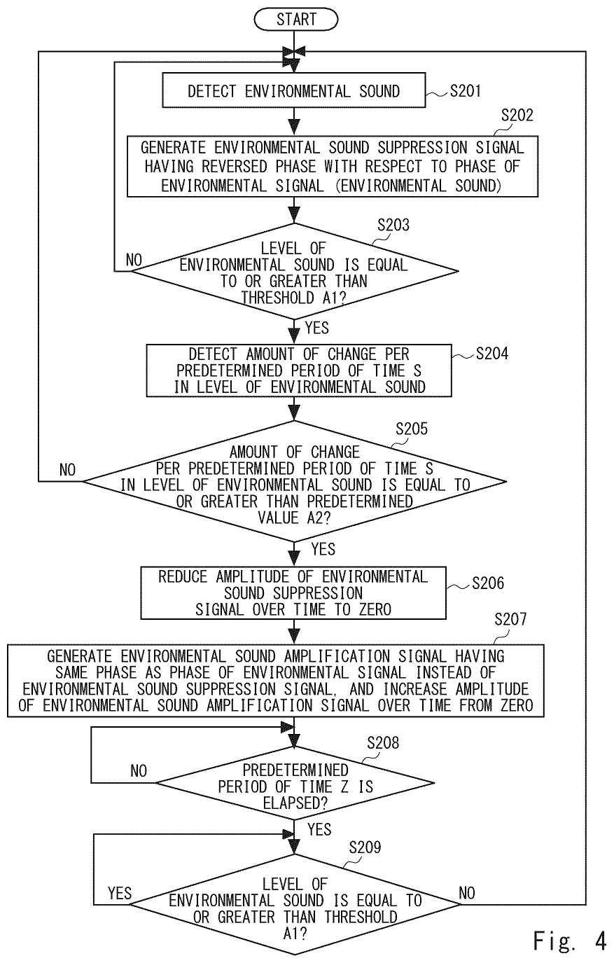

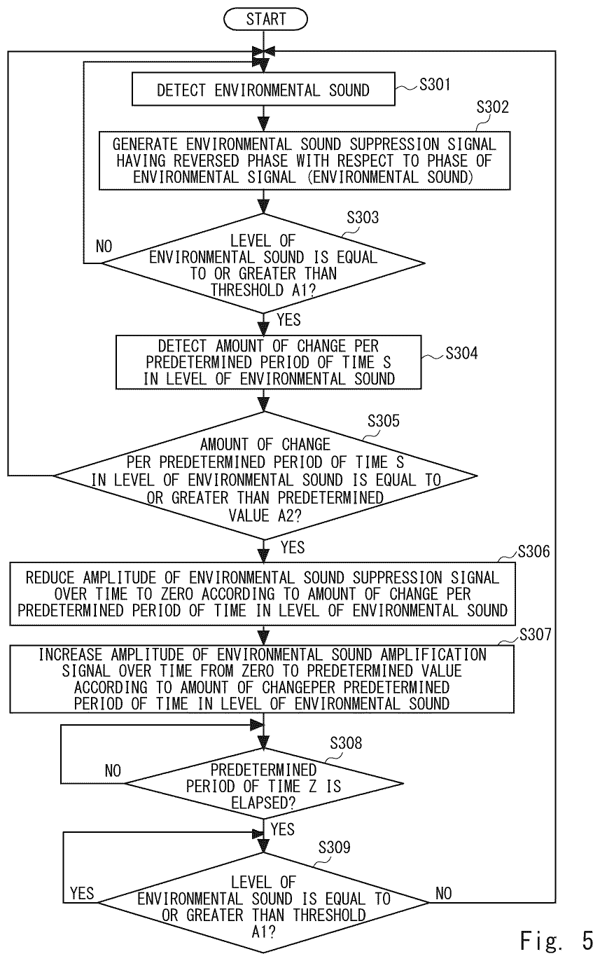

Next, an operation of the listening apparatus 200 according to the second embodiment will be described with reference to FIGS. 4 and 5.

FIG. 4 is a flowchart showing an example of the operation of the listening apparatus 200 according to the second embodiment.

First, the environmental sound detection unit 101 of the listening apparatus 200 detects an environmental sound around a user wearing the listening apparatus 200 (step S201). Then, the environmental sound detection unit 101 generates an environmental signal corresponding to the detected environmental sound.

Next, the environmental sound suppression signal generation unit 103 reverses a phase of the environmental signal, and generates the environmental sound suppression signal having a reversed phase with respect to the environmental signal (step S202). The reproduction signal output unit 105 converts a reproduction signal that is obtained by superimposing the environmental sound suppression signal on a sound source signal, into a reproduction sound, and outputs the reproduction sound to the user. The listening apparatus 200 thus performs a process of cancelling the environmental sound in the reproduction sound that is to be heard by the user.

Next, the monitoring unit 102 determines whether the level of the environmental sound is equal to or greater than the threshold A1 or not (step S203). As the threshold A1, a value that enables detection of a danger to a user is set.

In the case where the level of the environmental sound is determined to be not equal to or greater than the threshold A1 (NO in step S203), the listening apparatus 200 returns to the process in step S201. On the other hand, in the case where the level of the environmental sound is determined to be equal to or greater than the threshold A1 (YES in step S203), the monitoring unit 102 detects an amount of change per predetermined period of time S in the level of the environmental sound (step S204). The predetermined period of time S is 500 ms, for example.

Next, the monitoring unit 102 determines whether the amount of change per predetermined period of time S in the level of the environmental sound is equal to or greater than the predetermined value A2 or not (step S205). As in the case of the threshold A1, a value that enables detection of a danger to a user is set as the predetermined value A2.

In the case where the amount of change per predetermined period of time S in the level of the environmental sound is determined to be not equal to or greater than the predetermined value A2 (NO in step S205), the listening apparatus 200 returns to the process in step S201. On the other hand, in the case where the amount of change per predetermined period of time S in the level of the environmental sound is determined to be equal to or greater than the predetermined value A2 (YES in step S205), the environmental sound suppression signal generation unit 103 of the listening apparatus 200 reduces amplitude of the generated environmental sound suppression signal over time to zero (step S206). The amplitude of the environmental sound suppression signal does not necessarily have to be reduced by the environmental sound suppression signal generation unit 103 to zero, and other settings are also possible. A period of time over which the amplitude of the environmental sound suppression signal is to be reduced is approximately the same as the predetermined period of time S, for example.

Next, the environmental sound suppression signal generation unit 103 generates, instead of the environmental sound suppression signal, the environmental sound amplification signal having the same phase as the environmental signal, and increases amplitude of the environmental sound amplification signal over time from zero to a predetermined value (step S207). The amplitude of the environmental sound amplification signal that is first generated by the environmental sound suppression signal generation unit 103 is not limited to zero, and other settings are also possible. The predetermined value may be set based on a desired extent of amplification of the environmental sound. A period of time over which the amplitude of the environmental sound suppression signal is to be increased is approximately the same as the predetermined period of time S, for example.

Additionally, in step S207, the environmental sound suppression signal generation unit 103 may alternatively stop the environmental sound suppression signal without generating the environmental sound amplification signal.

Next, the monitoring unit 102 determines whether there is a lapse of a predetermined period of time Z from the process in step S206 or not (step S208). In the case where it is determined that the predetermined period of time Zis not elapsed (NO in step S208), the monitoring unit 102 returns to the process in step S208. On the other hand, in the case where it is determined that there is a lapse of the predetermined period of time Z (YES in step S208), the monitoring unit 102 determines whether the level of the environmental sound is equal to or greater than the threshold A1 or not (step S209). In the case where the level of the environmental sound is determined to be equal to or greater than the threshold A1 (YES in step S209), the listening apparatus 200 returns to the process in step S209. On the other hand, in the case where the level of the environmental sound is determined to be not equal to or greater than the threshold A1 (NO in step S209), the listening apparatus 200 returns to the process in step S201.

Then, in step S202, at the time of generating the environmental sound suppression signal instead of the environmental sound amplification signal, the environmental sound suppression signal generation unit 103 may reduce the amplitude of the environmental sound amplification signal over time to zero, and may increase the amplitude of the generated environmental sound suppression signal over time from zero to the predetermined value.

FIG. 5 is a flowchart showing another example of the operation of the listening apparatus 200 according to the second embodiment. In the example shown in FIG. 5, the listening apparatus 200 further performs an operation of determining at least one of an amount by which the amplitude of the environmental sound suppression signal is to be reduced over time and an amount by which the amplitude of the environmental sound amplification signal is to be increased over time, based on the amount of change per predetermined period of time S in the level of the environmental sound.

First, the listening apparatus 200 performs the processes from step S301 to step S305. The processes from step S301 to step S305 that are performed by the listening apparatus 200 are the same as the processes from step S201 to step S205 described above, and thus, description thereof will be omitted.

Next, in the case where the amount of change per predetermined period of time S in the level of the environmental sound is determined to be equal to or greater than the predetermined value A2 (YES in step S305), the environmental sound suppression signal generation unit 103 of the listening apparatus 200 reduces the amplitude of the environmental sound suppression signal over time to zero, according to the amount of change per predetermined period of time S in the level of the environmental sound (step S306). More specifically, the environmental sound suppression signal generation unit 103 determines an amount of reduction per unit time by which the amplitude of the environmental sound suppression signal is to be reduced, according to the amount of change per predetermined period of time S in the level of the environmental sound. Here, the environmental sound suppression signal generation unit 103 increases the amount of reduction per unit time, the greater the amount of change per predetermined period of time S in the level of the environmental sound. On the other hand, the environmental sound suppression signal generation unit 103 reduces the amount of reduction per unit time, the smaller the amount of change per predetermined period of time S in the level of the environmental sound. Then, the environmental sound suppression signal generation unit 103 reduces the amplitude of the environmental sound suppression signal to zero by the determined amount of reduction per unit time.

Next, the environmental sound suppression signal generation unit 103 generates, instead of the environmental sound suppression signal, the environmental sound amplification signal having the same phase as the environmental signal, and increases the amplitude of the environmental sound amplification signal over time from zero to the predetermined value, according to the amount of change per predetermined period of time S in the level of the environmental sound (step S307). More specifically, the environmental sound suppression signal generation unit 103 generates the environmental sound amplification signal instead of the environmental sound suppression signal. Then, the environmental sound suppression signal generation unit 103 determines an amount of increase per unit time by which the amplitude of the environmental sound amplification signal is to be increased, according to the amount of change per predetermined period of time S in the level of the environmental sound. Here, the environmental sound suppression signal generation unit 103 increases the amount of increase per unit time, the greater the amount of change per predetermined period of time S in the level of the environmental sound. On the other hand, the environmental sound suppression signal generation unit 103 reduces the amount of increase per unit time, the smaller the amount of change per predetermined period of time S in the level of the environmental sound. Moreover, the environmental sound suppression signal generation unit 103 increases the amplitude of the environmental sound amplification signal from zero to the predetermined value by the determined amount of increase per unit time.

Next, the listening apparatus 200 performs the processes in step S308 and step S309. The processes in step S308 and step S309 that are performed by the listening apparatus 200 are the same as the processes in step S208 and step S209 described above, and thus, description thereof will be omitted.

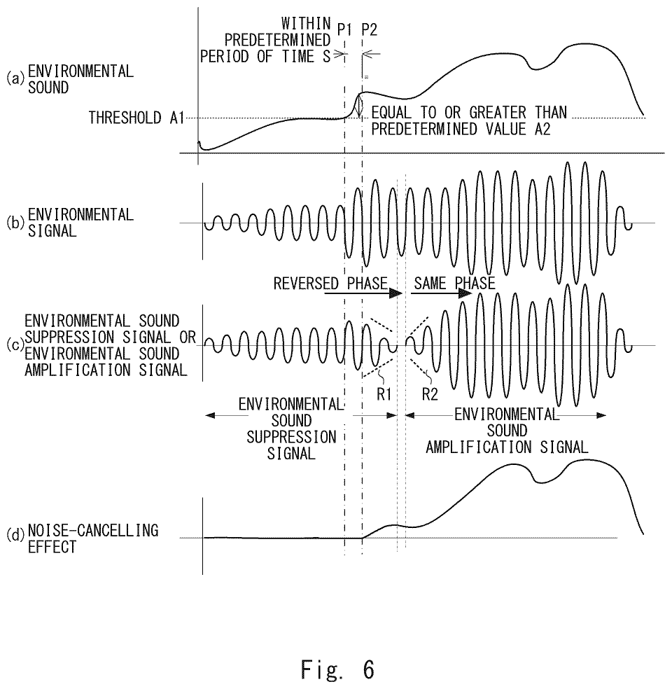

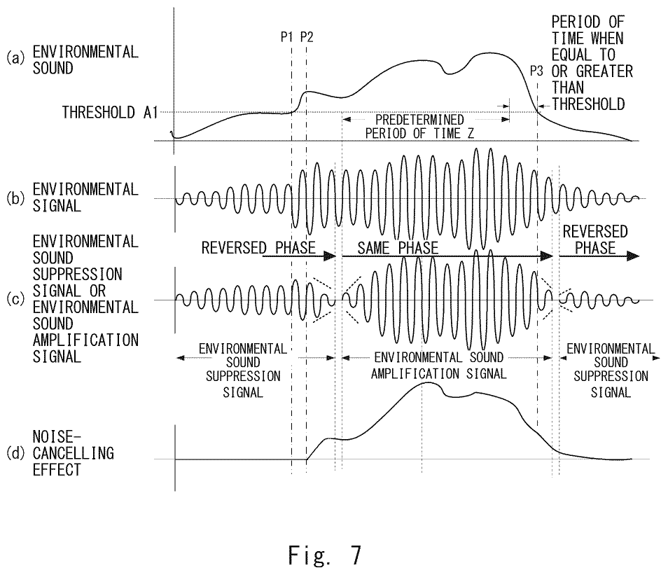

Next, the environmental sound suppression signal or the environmental sound amplification signal that is generated from the environmental sound by the listening apparatus 200 according to the second embodiment, and a noise-cancelling effect thereof will be described with reference to FIGS. 6 and 7.

FIGS. 6(a) to 6(d) and FIGS. 7(a) to 7(d) are diagrams showing the environmental sound suppression signal or the environmental sound amplification signal that is generated from the environmental sound by the listening apparatus 200 according to the second embodiment, and a noise-cancelling effect thereof.

FIGS. 6(a) and 7(a) are graphs showing the level of the environmental sound per unit time. Horizontal axes indicate time (ms), and vertical axes indicate a level (dB) of the environmental sound. FIGS. 6(b) and 7(b) are graphs showing a waveform of the environmental signal. Horizontal axes indicate time (ms), and vertical axes indicate amplitude (dB) of the environmental signal. Furthermore, FIGS. 6(c) and 7(c) are graphs showing a waveform of the environmental sound suppression signal or the environmental sound amplification signal. Horizontal axes indicate time (ms), and vertical axes indicate amplitude (dB) of the environmental signal. FIGS. 6(d) and 7(d) are graphs showing a noise-cancelling effect. Horizontal axes indicate time (ms), and vertical axes indicate a noise-cancelling effect (dB). The smaller the value of the noise-cancelling effect, the smaller the noise, or in other words, the environmental sound, in the reproduction sound that is heard by the user.

As shown in FIG. 6(a), at a time point P1, the level of the environmental sound is determined by the monitoring unit 102 of the listening apparatus 200 to be equal to or greater than the threshold A1. At a time point P2, the amount of change per predetermined period of time S in the level of the environmental sound is determined by the monitoring unit 102 to be equal to or greater than the predetermined value A2.

As shown in FIGS. 6(b) and 6(c), up to the time point P2, the environmental sound suppression signal having a reversed phase with respect to the environmental signal is generated by the environmental sound suppression signal generation unit 103. From a timing of the time point P2, the amplitude of the environmental sound suppression signal is reduced over time to zero by the environmental sound suppression signal generation unit 103. Here, an amount of reduction R1 per unit time in the amplitude of the environmental sound suppression signal may be determined by the environmental sound suppression signal generation unit 103 according to the amount of change per predetermined period of time S in the level of the environmental sound. Then, the environmental sound amplification signal having the same phase as the environmental signal is generated by the environmental sound suppression signal generation unit 103 instead of the environmental sound suppression signal, and the amplitude of the environmental sound amplification signal is increased over time from zero to the predetermined value. Here, an amount of increase R2 per unit time in the amplitude of the environmental sound amplification signal may be determined by the environmental sound suppression signal generation unit 103 according to the amount of change per predetermined period of time S in the level of the environmental sound. Accordingly, as shown in FIG. 6(d), the environmental sound heard by the user is cancelled until the time point P2. From the time point P2, the user is allowed to hear the environmental sound. Here, the user is allowed to hear the environmental sound gradually over time from the time point P2.

Next, as shown in FIG. 7(a), at a time point P3, after a lapse of the predetermined period of time Z from generation of the environmental sound amplification signal, it is determined by the monitoring unit 102 of the listening apparatus 200 that the level of the environmental sound is not equal to or greater than the threshold A1.

As shown in FIGS. 7(b) and 7(c), after the time point P3, the amplitude of the environmental sound amplification signal is reduced over time by the environmental sound suppression signal generation unit 103. Then, the environmental sound suppression signal is generated by the environmental sound suppression signal generation unit 103 instead of the environmental sound amplification signal, and the amplitude of the environmental sound suppression signal is increased over time. Accordingly, as shown in FIG. 7(d), after the time point P3, the environmental sound gradually ceases to be heard by the user over time.

As described above, the listening apparatus 200 according to the second embodiment reduces the amplitude of the environmental sound suppression signal over time, and then, generates the environmental sound amplification signal instead of the environmental sound suppression signal, and increases the amplitude of the environmental sound amplification signal over time. Accordingly, with the listening apparatus 200, a possibility that the user suddenly hears the environmental sound and gets annoyed by the reproduction sound may be reduced.

Moreover, the listening apparatus 200 determines, based on the amount of change per predetermined period of time S in the level of the environmental sound, at least one of the amount by which the amplitude of the environmental sound suppression signal is to be reduced over time and the amount by which the amplitude of the environmental sound amplification signal is to be increased over time. For example, in a case where there is an imminent danger to a user, such as a vehicle suddenly approaching the user, the amount of change per predetermined period of time in the level of the environmental sound is increased. With the listening apparatus 200, when there is an imminent danger to a user, the user is able to swiftly hear the environmental sound.

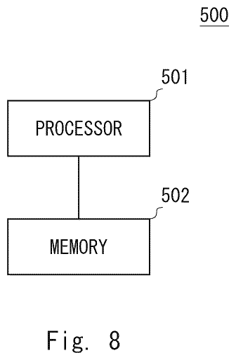

Next, an example of a hardware configuration of a computer 500 of the listening apparatus 100 according to the first embodiment and the listening apparatus 200 according to the second embodiment will be described with reference to FIG. 8. FIG. 8 is a block diagram showing an example of the hardware configuration of the computer 500. As shown in FIG. 8, the computer 500 includes a processor 501 and a memory 502. For example, the processor 501 may be a microprocessor, a micro processing unit (MPU), or a central processing unit (CPU). The processor 501 may include a plurality of processors. The memory 502 is a combination of a volatile memory and a non-volatile memory. The memory 502 may include a storage that is disposed separate from the processor 501. In this case, the processor 501 may access the memory 502 via an I/O interface, not shown.

Moreover, each element of the embodiments described above may be configured by hardware or software, or by both hardware and software, and may be configured by one piece of hardware or software, or a plurality of pieces of hardware or software. A function (processing) of each element of the embodiments described above may be implemented by a computer. For example, programs for performing methods of the embodiments may be stored in the memory 502, and each function may be implemented through execution, by the processor 501, of a program stored in the memory 502.

The programs each contain a set of instructions (or software codes) that, when loaded into a computer, causes the computer to perform one or more of the functions described in the embodiments. The programs may be stored in a non-transitory computer-readable medium or a tangible storage medium. For example, computer-readable media or tangible storage media can include a random-access memory (RAM), a read-only memory (ROM), a flash memory, a solid-state drive (SSD) or other memory technologies, a CD-ROM, a digital versatile disc (DVD), a Blu-ray (registered mark) disc or other optical disk storage, a magnetic cassette, a magnetic tape, a magnetic disk storage or other magnetic storage devices. The programs may be transmitted on a transitory computer-readable medium or a communication medium. For example, transitory computer-readable media or communication media can include electrical, optical, acoustical, and other forms of propagated signals.

Additionally, the present invention is not limited to the embodiments described above, and can be changed as appropriate within the scope of the invention.

The present disclosure is applicable to a listening apparatus such as noise-cancelling earphones or headset, for example.

What is claimed is:

1. A listening apparatus comprising:
an environmental sound detection unit configured to generate an environmental signal corresponding to an environmental sound that is detected;
an environmental sound suppression signal generation unit configured to generate an environmental sound suppression signal having a reversed phase with respect to the environmental signal;
a reproduction signal output unit configured to output a reproduction signal that is obtained by superimposing the environmental sound suppression signal on a sound source signal; and
a monitoring unit configured to monitor a level of the environmental sound based on the environmental signal, wherein
the environmental sound suppression signal generation unit generates an environmental sound amplification signal having the same phase as the environmental signal instead of the environmental sound suppression signal, in a case where it is determined by the monitoring unit that the level of the environmental sound is equal to or greater than a predetermined threshold and that an amount of change per predetermined period of time in the level of the environmental sound is equal to or greater than a predetermined value, and
the reproduction signal output unit outputs a reproduction signal that is obtained by superimposing the environmental sound amplification signal on the sound source signal.

2. The listening apparatus according to claim 1, wherein, in a case where it is determined by the monitoring unit that the level of the environmental sound is equal to or greater than the predetermined threshold and that the amount of change per predetermined period of time in the level of the environmental sound is equal to or greater than the predetermined value, the environmental sound suppression signal generation unit reduces amplitude of the environmental sound suppression signal over time, and then increases amplitude of the environmental sound amplification signal over time.

3. The listening apparatus according to claim 2, wherein at least one of an amount of reduction over time in the environmental sound suppression signal and an amount of increase over time in the environmental sound amplification signal is determined based on the amount of change per predetermined period of time in the level of the environmental sound.

4. The listening apparatus according to claim 1, wherein, in a case where it is determined by the monitoring unit that the level of the environmental sound is equal to or greater than the predetermined threshold and that the amount of change per predetermined period of time in the level of the environmental sound is equal to or greater than the predetermined value, the environmental sound suppression signal generation unit stops the environmental sound suppression signal without generating the environmental sound amplification signal.

5. A control method of a listening apparatus comprising:
generating an environmental signal corresponding to an environmental sound that is detected;
generating an environmental sound suppression signal having a reversed phase with respect to the environmental signal;
outputting a reproduction signal that is obtained by superimposing the environmental sound suppression signal on a sound source signal;
monitoring a level of the environmental sound based on the environmental signal; and
generating an environmental sound amplification signal having the same phase as the environmental signal instead of the environmental sound suppression signal, in a case where it is determined that the level of the environmental sound is equal to or greater than a predetermined threshold and that an amount of change per predetermined period of time in the level of the environmental sound is equal to or greater than a predetermined value, and outputting a reproduction signal that is obtained by superimposing the environmental sound amplification signal on the sound source signal.
